(19) United States
(12) Patent Application Publication
(10) Pub. No.: US 2019/0378407 A1
(43) Pub. Date: Dec. 12, 2019

(54) METHOD FOR INFORMING AT LEAST ONE RECEIVER VEHICLE ABOUT A WRONG-WAY VEHICLE, AND SERVER DEVICE AND MOTOR VEHICLES

(71) Applicant: AUDI AG, Ingolstadt (DE)

(72) Inventor: Dr. Pedro Sebastiao CORREIA, Marbach am Neckar (DE)

(73) Assignee: AUDI AG, Ingolstadt (DE)

(21) Appl. No.: 16/471,080

(22) PCT Filed: Jan. 9, 2018
(86) PCT No.: PCT/EP2018/050400

§ 371 Date: Jun. 19, 2019

(30) Foreign Application Priority Data
Feb. 8, 2017 (DE) 10 2017 201 924.7

(51) Int. Cl. G08G 1/01; G08G 1/056; G08G 1/0967

(52) U.S. Cl. CPC G08G 1/0141; G08G 1/056; G08G 1/0133; G08G 1/096741; G08G 1/09675; G08G 1/096725

(57) ABSTRACT

The present application provides a method for notifying at least one receiver vehicle about a wrong-way driver vehicle, wherein a stationary server device receives from the wrong-way driver vehicle wrong-way driver data describing its current position. The invention provides that the server device provides a digital road map, which is divided into sub-areas of pre-determined size, and selects, in the road map based on the wrong-way driver data, that sub-area in which the wrong-way driver vehicle is located, and updates the map data of the selected sub-area by means of the wrong-way driver data and transmits the updated map data to the at least one receiver vehicle, and the at least one receiver vehicle enters the received map data into an on-board digital road map and checks on the on-board road map whether the wrong-way driver vehicle for the receiver vehicle fulfills a pre-determined relevance criterion, wherein if the relevance criterion is met, a protective measure is performed in the receiver vehicle.

### TECHNICAL FIELD

The present application relates to a method for notifying at least one motor vehicle about a wrong-way driver vehicle. The at least one motor vehicle is hereinafter referred to in each case as a receiver vehicle, since it is the respective receiver of the information about the wrong-way driver vehicle. The at least one receiver vehicle is informed by a stationary server device about the wrong-way driver vehicle. The present application also includes the server device and a motor vehicle which can communicate with the server device as a receiver vehicle, as well as a motor vehicle which independently detects a wrong-way or ghost rider.

### BACKGROUND

Nowadays, warning messages, such as from wrong-way drivers, are broadcast via the TMC channel (TMC—Traffic Message Channel) in navigation devices or on traffic radio stations via radio channels. There is usually a significant delay involved compared to the occurrence of the traffic event. These messages are not sent specifically to the relevant region, but globally, at least relative to the transmitter range. This means that the message has no relation to the current whereabouts of a receiver vehicle or its route. However, the messages are only relevant to receiver vehicles in the vicinity of the traffic event and only when the receiver vehicle is approaching the traffic event. Furthermore, messages about wrong-way drivers must also be forwarded to a receiver vehicle with a short time delay in order to achieve the maximum benefit.

From DE 10 2014 106 445 B3 a motor vehicle is known which automatically detects if it is driving the wrong way. The motor vehicle can then report current location coordinates and the direction of travel to a central location.

From DE 10 2013 007 866 A1 a server device is known which selectively sends a warning about a wrong-way driver, but only to those motor vehicles whose current position and route have a relationship to the position of the wrong-way driver vehicle. A problem arises of how to identify such receiver vehicles.

### BRIEF DESCRIPTION OF THE DRAWINGS/FIGURES

FIG. 1 is a schematic representation of a system, in accordance with some embodiments.

### DETAILED DESCRIPTION

The present application is based on the object of notifying a respective driver of at least one receiver vehicle specifically about a wrong-way driver vehicle which is relevant to his route, and/or to otherwise protect him against it.

The problem is solved by the subject matter of the independent claims. Advantageous developments of the present application are disclosed by the features of the dependent claims, the following description, and the drawings.

In accordance with some embodiments, the present application provides a method by means of which at least one receiver vehicle is informed about a wrong-way driver vehicle. For this purpose, a stationary server device receives from the wrong-way driver vehicle or from another motor vehicle or from a permanently installed monitoring device wrong-way driver data which describe at least one position of the wrong-way driver vehicle. Optionally, the wrong-way driver data may also indicate a current direction of travel and/or a planned and/or estimated route and/or a travel speed and/or a currently traveled lane or lane, for example. In order for the server device to promptly trigger a protective measure in the at least one receiver vehicle based on the wrong-way driver data, the following is provided. The server device provides a digital road map that is divided into sub-areas of pre-determined size. For example, as each sub-area, a tile can be used whose edge length can be in a range of 0.01 degrees to 0.1 degrees. The degree refers to the longitude and the latitude. Such a sub-area constitutes a segment of the road map and comprises or describes a sub-area in which a motor vehicle can be located. On the road map, the server device uses the wrong-way driver data to select the sub-area in which the wrong-way driver vehicle is located. The map data of the selected sub-area is then updated by means of the wrong-way driver data. This now makes available to the sub-area map data which also contain an entry or a description of the wrong-way driver vehicle. These updated map data of the sub-area are sent to the at least one receiver vehicle. The at least one receiver vehicle enters the received map data into an on-board digital road map. Now it has to be decided whether the respective driver of the at least one receiver vehicle should take protective measures. To this end, the at least one receiver vehicle checks on the on-board road map whether the wrong-way driver vehicle for the receiver vehicle fulfills a pre-determined criterion of relevance. If the relevance criterion is met, at least one pre-determined protective measure is carried out in the receiver vehicle. The receiver vehicle receives the map data, but does not immediately perform the at least one protective measure. Rather, based on the on-board road map, a check is first performed as to whether the wrong-way driver vehicle is relevant at all for the receiver vehicle. By using the road map, it is also possible to match a route planned or estimated by the receiver vehicle with the position of the wrong-way driver vehicle or its wrong-way driver data. In this case, the entire road map does not have to be transmitted from the server device to the receiver vehicle, but by dividing the road map into sub-areas and generating updated map data for only one sub-area, only that sub-area of the road map required to display the wrong-way driver vehicle is displayed, i.e. the sub-area with the wrong-way driver vehicle in it, to enter or update the receiver vehicle in its on-board road map. If the wrong-way driver data also indicates the route of the wrong-way driver vehicle, it is also possible to check whether the route of travel of the receiver vehicle and the route of the wrong-way driver vehicle are likely to intersect.

The advantage of the present application is that the server device, by providing the map data, enables each receiver vehicle to determine for itself using the on-board road map or to determine whether the wrong-way driver vehicle is relevant, i.e. fulfills the relevance criterion, and then only if the relevance criterion is met at least one pre-determined safety measure is performed in the respective receiver vehicle. A driver of the receiver vehicle is affected by the at least one pre-determined protective measure only if the wrong-way driver vehicle is actually relevant or dangerous.

A wrong-way driver vehicle is to be understood in particular as meaning a motor vehicle which moves on a road which has two structurally separate road sides, each with a pre-determined uniform direction of travel, counter to the prescribed direction of travel of the road side on which it is traveling.

The present application also covers optional developments, the features of which result in additional advantages.

In accordance with some embodiments, the server device transmits the map data to a plurality of receiver vehicles, irrespective of their respective current own position and/or route and each receiver vehicle decides for itself whether the wrong-way driver vehicle is relevant. The server device thus transmits the map data as a broadcast signal. The relevance is then individually checked exclusively in the receiver vehicles by means of the relevance criterion. Alternatively, the at least one receiver vehicle may register to receive certain sub-areas. For this purpose, it can be provided that the server device receives registration data from each of the receiver vehicles, by means of which the respective receiver vehicle registers for at least one respective sub-area. The server device therefore knows which of the at least one sub-area the respective receiver vehicle wishes to be informed about, since the receiver vehicle has registered for the respective sub-area. The server device sends out the updated map data only to that at least one receiver vehicle of the plurality of receiver vehicles which is registered for the sub-area in which the wrong-way driver vehicle is located and/or which the wrong-way vehicle is approaching. A receiver vehicle can thus register the sub-area in which it is currently located and/or at least one adjacent sub-area in each case at the server device by means of registration data. Then, the receiver vehicle is supplied with map data only if the wrong-way driver vehicle is located in a registered sub-area and/or the wrong-way driver vehicle approaches it. By means of this registration, the server device performs a targeted preselection of the at least one receiver vehicle for the transmission or broadcasting of the updated map data.

If the map data now exists in a receiver vehicle, the vehicle must decide whether the wrong-way driver vehicle is relevant for the current journey of the receiver vehicle. In accordance with some embodiments, the relevance criterion used for this purpose preferably includes the case that a planned or estimated route of the receiver vehicle intersects a route of the wrong-way driver vehicle. A planned route can be read out or received from a respective navigation device. An estimated route can be determined, for example, based on historical driving data of the respective receiver vehicle and/or a statistical description of a possible route of the respective receiver vehicle. Additionally or alternatively, the relevance criterion can include the case that the wrong-way driver vehicle must be in front of the receiver vehicle in the direction of travel thereof If the wrong-way driver vehicle is already behind the receiver vehicle in the direction of travel, then the wrong-way driver vehicle can no longer be dangerous to the receiver vehicle and is therefore irrelevant. Additionally or alternatively, the relevance criterion may include that the wrong-way driver vehicle route data indicate the same road as the route data of the receiving vehicle. By considering the route, if the wrong-way driver is on a highway and the receiver vehicle is on a parallel country road and travelling in different directions, the relevance criterion is not met. In the case where the receiver vehicle and the forwarder vehicle are traveling on the same road, the relevance criterion preferably includes the requirement that the wrong-way driver vehicle drive on the same road side as the receiver vehicle. By road side, what is meant is each half of the road on which a uniform direction is prescribed for road lanes which are the structurally separate.

By compiling the relevance criterion with the conditions mentioned, it is therefore possible to ensure that the at least one protective measure is only carried out if the wrong-way driver vehicle is traveling on the same road relative to the receiver vehicle and is still in front of the receiver vehicle and if it can be assumed that the routes of the two vehicles intersect or cross.

In accordance with some embodiments, if the relevance criterion is met, the at least one protective measure may be carried out. The at least one protective measure preferably comprises that a notification is issued to the receiver vehicle concerning the wrong-way driver vehicle. This results in a driver or vehicle occupant of the receiver vehicle being warned. Additionally or alternatively, the at least one protective measure preferably comprises activating an autopilot device for entering semi-automatic or fully automatic mode in the receiver vehicle and programming or setting the autopilot device for an evasive maneuver for avoiding the wrong-way driver vehicle. Fully automatic driving mode provides for longitudinal guidance (acceleration and deceleration) and transverse guidance (steering) of the receiver vehicle through the autopilot device. Semi-automatic driving mode provides only longitudinal guidance or transverse guidance. Semi-automatic driving mode can be limited to an emergency stop, for example. By activating the autopilot device, the receiver vehicle can react faster than a driver of the receiver vehicle could.

In accordance with yet another embodiments, to warn further road users in the sub-area in which the wrong-way driver vehicle is located, the server device can also issue at least one control signal by means of which the server device switches at least one variable traffic sign and/or one electronic sign gantry. For example, a variable traffic sign can be designed using light-emitting diodes, the activation of which able to provide a pixel-by-pixel roadside representation of information about the wrong-way driver vehicle. An electronic sign gantry can span the road and display a pixel-by-pixel representation of the information based on light-emitting diodes or other light sources, for example.

So far, it has been described that the server device receives the required wrong-way data from the wrong-way driver vehicle. How this wrong-way data are determined has not been described. In accordance with some embodiments, it is provided that in the wrong-way driver vehicle a monitoring device uses a current position and a digital road map to detect the wrong-way or ghost driver by recognizing a currently used road class with direction-of-travel separation. For example, such a road class can be a highway or a free-way. By means of a sensor device and a downstream object recognition system, oncoming traffic (oncoming motor vehicles) and/or at least a sign can be detected by the monitoring device. For example, the sign can be a warning on an on-ramp or off-ramp of a highway regarding an incorrect direction of travel. A back of a sign can also be detected, which can also provide evidence of a ghost ride or wrong-way driver. For example, the sensor device can comprise a camera for generating image data or video data. Object detection can be provided, for example, based on a microprocessor or microcontroller as well as based on an image recognition algorithm. The monitoring device may additionally or alternatively detect that a highway or expressway off-ramp has been entered (instead of an on-ramp or entrance) based on a steering angle signal of the wrong-way driver vehicle. This can be distinguished at the steering device and based on the digital road map.

In accordance with some embodiments, to carry out the method a server device for notifying at least one receiver vehicle about a wrong-way driver vehicle is disclosed. The server device is set up for stationary server operation on the Internet. For this purpose, the server device can have a computer or a computer network which can be connected to the Internet. The server device has a processor device, which is set up to receive from the wrong-way driver vehicle wrong-way driver data which describe at least a current position of the wrong-way driver vehicle. The processor device can receive at least one microprocessor and/or at least one microcontroller. The method steps performed by the server device in operation can be provided by program code that can be executed by the processor device. The server device according to the invention has a digital road map, which is divided into sub-areas of pre-determined size. The processor device is set up to detect or select, in the road map based on the wrong-way driver data, the sub-area in which the wrong-way driver vehicle is located and to update map data of the selected sub-area by means of the wrong-way driver data and to send the updated map data of the sub-area to the at least one receiver vehicle. In accordance with some embodiments, a motor vehicle which have features such as those previously described in connection with the further embodiments of the method is disclosed. For this reason, the corresponding further embodiments of the safety system according to the invention are not described again here.

In accordance with some embodiments, a motor vehicle which is set up as a receiver vehicle for the server device is disclosed. The motor vehicle checks the updated map data for relevance. For this purpose, the motor vehicle comprises a control device, which has a processor device which is adapted to receive map data received from the server device and which indicate in an on-board digital road map a sub-area in which a wrong-way driver vehicle is located, enter the data into the on-board road map and check on the on-board road map to see if the wrong-way driver vehicle for the receiver vehicle meets a pre-determined relevance criterion, and to perform at least one pre-determined protective measure in the receiver vehicle when the relevance criterion is met. The control device of the motor vehicle can be designed as a controller, for example. The processor device can have at least one microprocessor and/or one microcontroller. To perform the described steps, the processor device may comprise a program code which is set up to perform the steps when executed by the processor device.

The present application also includes further embodiments of the motor vehicle, which have features such as those previously described in connection with the further embodiments of the process as described herein. For this reason, the corresponding further embodiments of the motor vehicle are not described again here.

In accordance with some embodiments, for the server device to be able to receive wrong-way driver data, a motor vehicle with a monitoring device for detecting a wrong-way drive is disclosed. The monitoring device is set up to detect the wrong-way status by the monitoring device by recognizing a currently used road class with direction-of-travel separation based on a current position of the motor vehicle and a digital road map, and by recognizing, by means of a sensor device and a downstream object detection system, on-coming traffic and/or at least one sign and/or by recognizing driving onto an off-ramp (instead of an on-ramp) on a highway or expressway by means of a steering angle signal of the motor vehicle, wherein the monitoring device is configured to transmit to a vehicle-external server device, by means of a communication device, data which describe at least a current position of the wrong-way driver vehicle once the wrong-way status has been detected. The wrong-way driver data naturally makes the motor vehicle recognizable as a wrong-way driver vehicle with respect to the server device. The monitoring device can be a program module for a processor device of the motor vehicle, for example. The processor device may in the manner described have at least one microcontroller and/or at least one microprocessor, and be configured to execute the program code.

The present application also includes further embodiments of the motor vehicle, which have features such as those previously described in connection with the further embodiments of the process as described herein. For this reason, the corresponding further embodiments of the motor vehicle are not described again here.

In accordance with some embodiments, the server device and the at least one receiver vehicle and the wrong-way driver vehicle together form a system.

The embodiments explained below are preferred embodiments of the invention. In the embodiments, the described components of the embodiments constitute individual features to be considered independently of one another and/or in a different combination as already described herein. In addition, additional features to those already described can also be added to the embodiments as described herein.

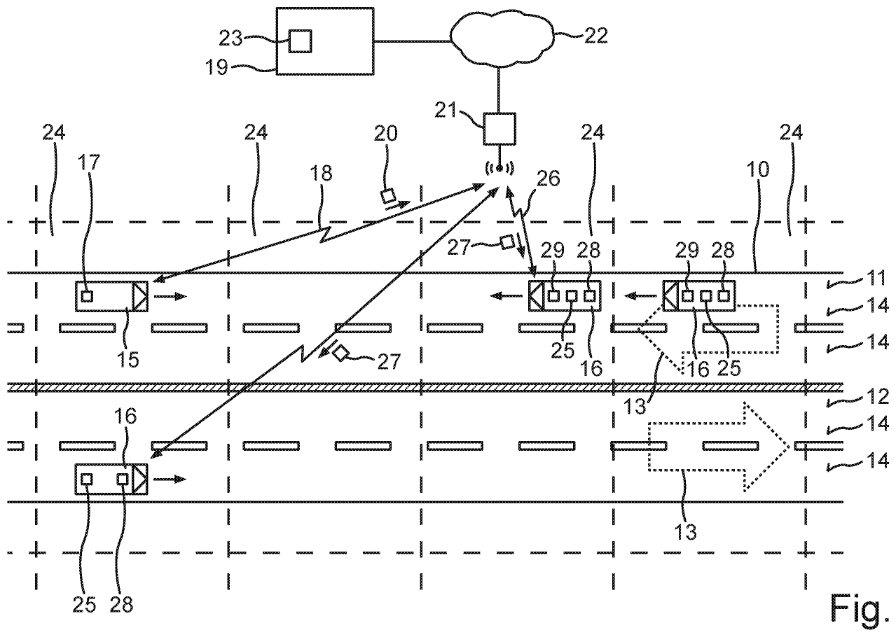

FIG. 1 shows a schematic representation of a system, in accordance with some embodiments. FIG. 1 shows a road 10 which can have structurally separate road sides 11, 12, there being one direction of travel 13 prescribed for each side. Each road side 11, 12 can have respective lanes 14, i.e. individual lanes on which vehicles can drive. On road side 11, a motor vehicle can travel in the opposite direction to that prescribed 13 as a wrong-way driver vehicle 15. Furthermore, receiver vehicles 16 can travel along the road 10.

The wrong-way driver vehicle 15 can detect the wrong-way status by means of its own monitoring device 17 and send out wrong-way data 20 via a radio link 18 to a server device 19. For example, by means of the radio connection, the wrong-way driver data 15 can be transmitted to a mobile radio network 21 (GSM, UMTS, LTE) and/or to a WLAN router. In this way, a communication connection to a server device 19 can be set up via the Internet 22 for transmitting the wrong-way driver data 20.

The server device 19 can have a road map 23 by means of which the road 10 and its surroundings are divided into sub-areas 24, which are shown by way of example in the figure, wherein for purposes of clarity only some of the sub-areas 24 are provided with a reference sign. The sub-areas 24 can be in the form of tiles, that is, a tile pattern or tile grid is used to divide the environment depicted in the roadmap 23. The receiver vehicles 16 can each have a road map 25 in which traffic events or warnings and their respective associated geoposition can be mapped or entered.

The server device 19 can send out updated map data 27 to the receiver vehicles 16 via a respective radio connection 26, by means of which the road maps 25 are updated such that for the sub-area 24 in which the wrong-way driver vehicle 15 travels, a corresponding entry or notification about the wrong-way driver vehicle 15 is entered or supplemented or updated based on the wrong-way data 20. Each receiver vehicle 16 can then itself check, based on a relevance criterion, whether the wrong-way driver vehicle 15 is relevant to its own route. The radio connections 26 can be set up in a readily known manner, for example based on a respective mobile radio module and/or WLAN radio module provided in the respective receiver vehicle 16.

When the relevance criterion 28 is met, at least one pre-determined protective measure 29 is carried out in the respective receiver vehicle 16.

The server device 19 thus represents a back-end system for the wrong-way driver vehicle 15 and the receiver vehicles 16.

By applying the method described below, it becomes possible to provide the relevant subscribers (receiver vehicles) with warning messages together with current location-time reference and/or with increased degree of detail of the information.

The essential components of the process are in particular:

detection of the wrong-way driver and warnings issued to said driver

communication between the vehicle (wrong-way driver) and the back-end (server device)

aggregation of the data in the back-end system and imparting the information onto the map material (preferably using swarm data)

communication with other vehicles (other road users, i.e. receiver vehicles)

assessment of the relevance of the information locally in the receiver vehicle

dynamic HMI interaction (HMI—Human Machine Interaction) with the subscriber using visual, acoustic or haptic parts

In accordance with some embodiments, a preferred technical implementation for carrying out the method is described. To implement the function, the following components can be provided, the functionality of which is described:

To detect a wrong-way driver, wrong-way driver data or information on the vicinity thereof is required. The wrong-way driver data can include, for example, predictive route data (PSD) or road data of a digital road map which maps the road network in which the vehicle is moving for navigation as well as for driver assistance systems. Among other things, the road data includes the road class (for example a highway). The positioning is supported by the GPS position (GPS—Global Positioning System) or another GNSS position (GNSS—Global Navigation Satellite System). If it is detected here that the vehicle is going in the wrong direction on the road network, this can be declared as a wrong-way driver (wrong-way status).

In accordance with some embodiments, as a plausibility source, a vehicle camera can also be consulted. If an object recognition system downstream of the vehicle camera detects that a “transit forbidden sign” has been passed, then the vehicle can be declared as a wrong-way driver. Under certain circumstances, other types of signs or traffic signs detected from the rear can also be used as the basis for declaring a wrong-way driver.

In accordance with yet another embodiments, in addition to sign recognition, the object recognition function of the camera can be used in other ways as well, or as an alternative. For example, if oncoming traffic is determined on a “highway” road class, then the vehicle can be declared as a wrong-way driver.

The steering angle sensor indicates the steering wheel position. In accordance with some embodiments, in conjunction with the position sensitive detector (PSD), a determination can be made as to whether the vehicle is entering the highway properly. Since on-ramps always enter the highway along a right turn, at least in Germany, this method can be used as a basis for determining a wrong-way driver. Thus, if a vehicle enters the highway in a left turn fashion, the vehicle can be declared as being a wrong-way driver.

The wrong-way driver vehicle thus recognizes itself as a wrong-way driver fully automatically. In accordance with some embodiments, if the detection is positive, the driver is warned and a message with wrong-way driver data is sent to a back-end system (server device).

In accordance with some embodiments, the warnings for the wrong-way driver and maneuver instructions can be configured as follows. The wrong-way driver can receive not only audible signals but also haptic and visual signals, in order to be informed that he is driving in the wrong direction.

Acoustic warning: The driver can be warned by an acoustic warning signal.

Visual warning: In addition to an audible warning, the driver can also be informed by a text or a directional arrow opposite to the direction of travel in the center display or combi display.

Haptic warning: In addition to audible warning and visual warnings, the driver can also receive haptic feedback. This can be done on the one hand by applying a back pressure on the accelerator pedal or a torque from the vehicle steering wheel (analogous to a lane departure warning) in the direction of the shoulder or by vibrating the steering wheel.

The driver can be advised to use a maneuver such as “reduce speed”, “please drive onto the shoulder”, “activate hazard warning lights” to resolve or defuse the dangerous situation.

In accordance with some embodiments, some of these points can also be done automatically according to the situation. It is also conceivable that in the future the vehicle goes into a piloted mode and fully automatically clarifies the situation by means of an autopilot device.

In accordance with some embodiments, the communication between the wrong-way driver vehicle (wrong-way driver) and the back-end (server device) is disclosed.

If at least one of the described criteria for detecting a wrong-way driver is met, the information about a wrong-driving vehicle is sent to the back-end system. This information can also be sent as an emergency call signal to other vehicles in the vicinity, the police or other emergency services.

In accordance with some embodiments, a communication unit with online connection can be provided as follows: To enable communication between the vehicle and the back-end system, a radio connection must exist. This radio connection can be made by a fixed communication device in the vehicle with online connection. This can include, for example, a modular infotainment kit (MIB infotainment system) or a connected gateway (cGW) with a mobile radio module and/or WLAN radio module (WLAN—Wireless Local Area Network). Furthermore, coupled devices (possibly coupling by means of Bluetooth, WLAN or cable, thus in general wireless or wired technologies), such as a smartphone or a tablet PC can be used to establish a connection between the vehicle and the back-end system.

In accordance with some embodiments, processing the data in the back-end system (server device), i.e. aggregation of the data in the back-end system and imparting the information to the map material is disclosed.

In order to know which vehicles are potentially endangered by a wrong-way driver, the following information about the wrong-way driver as wrong-way driver data should be provided for communication to the back-end system:

GPS position

lane

heading (direction of travel)

planned/estimated route

speed

This wrong-way driver data can be used and processed in the back-end in different ways. For example, various information of the wrong-way driver vehicle can be stored in a virtual, i.e. digital navigation map or road map in the back-end system. In this case, the wrong-way driver is depicted or imparted to the road network on file as a traffic event with a variety of attributes (e.g. heading/direction of travel of the vehicle, GPS position, time stamp, lane, speed, road class).

In the case of a segment-based map, in addition to the attributes mentioned, the segment ID and optionally an offset are also stored in order to simplify the mapping of the traffic event onto the map in the back-end system and then later in the vehicle of the other road users. Subsequently, this information is sent as updated map data to other vehicles.

In accordance with some embodiments, a communication to vehicles of other road users can be configured as follows. The vehicles move along a navigation map, i.e. an on-board, digital road map. This road map can be organized or divided into sub-areas, e.g. in the form of “tiles” of a defined size (e.g. a size of 0.05×0.05 degrees). A vehicle is always located exactly in one tile and knows its 8 direct neighbor tiles, for example.

In one embodiment, a broadcast mechanism is used. The back-end system sends the map data of the tile with updated information to all vehicles. This happens regardless of whether they are in or out of the affected tile.

In an alternative embodiment, a registration/notification mechanism is provided. Vehicles know their current tile, including their neighboring tiles, and use registration data to register in the back-end system for this subset of preferred tiles. This allows the back-end system to more efficiently and selectively send tiles with updated map data only to those vehicles that can derive a tangible benefit from the information. The relevant vehicles are thus notified by the back-end system of an update.

In accordance with some embodiments, in each receiver vehicle, an assessment of the relevance of the information takes place locally in the vehicle, i.e. a determination of the road users for whom the wrong-way driver message is relevant. As soon as it is known where a wrong-way driver is located, a virtual safe area can be outlined or defined around the receiver vehicle depending on the speed, for example. This “radius” can be 100 meters or up to 50 kilometers. For example, this area can be a tile with possibly its adjacent tiles. Based on the wrong driver information provided for the relevant geographic area (e.g. a tile or generally the area covered by the radius), each receiver vehicle may decide from local information such as heading, GPS position/GNSS position and planned/estimated route whether the wrong driver information is relevant.

In accordance with some embodiments, to make sure that the wrong-way driver is not already behind the user's receiver vehicle, the heading is also needed to avoid unnecessary warnings. In order to ensure that the receiver vehicle is actually on the same road and in the opposite direction of travel as the wrong-way driver, the route of the receiver vehicle must also be included. For example, a wrong-way driver on the highway and a receiver vehicle on a country road could be traveling in different directions. At the same time, if the distance of these two roads is less than the variance of the GPS/GNSS position determined, a warning message would be erroneously propagated. By viewing the route then a false report is counteracted. The travel route of the receiver vehicle can be taken from the set navigation destination or from an estimated route. A person skilled in the art can summarize the conditions corresponding to a relevance criterion.

In accordance with some embodiments, warnings and maneuvering instructions for wrong-way drivers can be generated for other road users in the receiver vehicles, and if the relevance is met, acoustic, visual and haptic warnings can be given analogous to the “warnings to the wrong-way driver and maneuver instructions” point.

The driver can be advised to use a maneuver such as “reduce speed”, “please drive onto the shoulder”, “activate hazard warning lights”.

In contrast to today's procedures, as a whole the described method provides up-to-date warnings which at the same time provide a higher accuracy and additional details. Details can include the lane used by the wrong-way driver and his speed, for example. This can better resolve or mitigate a dangerous situation. Due to the additional details, recommendations such as “change to the left/right side” (i.e. for this situation the “safe” lane) can be given. Some of these points can also be provided automatically according to the situation.

It is also conceivable that in the future the vehicle goes into a piloted mode and fully automatically clarifies the situation by means of an autopilot device. In addition, the vehicle can also sketch in a “wrong-way driver icon” symbol locally and dynamically on the navigation map displayed in the display or screen at the location of the wrong-way driver. Other vehicles that are not in the relevant area and are not driving in the relevant direction of travel would refrain from doing so.

Previous methods are characterized by a significant delay and distribute the warning over a geographically large area and do not target the relevant road users in the surroundings of the traffic event. The method described here enables the display of warnings with current location-time reference and/or accuracy as well as optional additional details. Details can be, for example, the lane used by the wrong-way driver and/or his speed. The automatic detection of a wrong-way driver and the immediate communication to other road users via a back-end system happens in real time. A time-consuming manual report by eyewitnesses and sending by means of TMC can be prevented.

In addition, the warning message can also be passed on to task forces or used for switching variable traffic signs and/or signals on electronic gantries.

Furthermore, in an anonymized aggregation of traffic events over a long time it can be determined whether wrong-way drivers have been reported at specific locations more frequently. This information can be made available to municipalities and cities in order to be able to carry out measures to better identify respective on-ramps being driven in the wrong direction.

Overall, the examples show a method for displaying local danger warnings with a current location-time reference and an integration of situation-specific information.

1.-10. (canceled)

11. A method for notifying at least one receiver vehicle about a wrong-way driver vehicle comprising:
receiving, at a stationary server device, wrong-way driver data;
producing, at the stationary server device, a digital road map divided into a plurality of sub-areas;
based on the wrong-way driver data, selecting, at the stationary server device, a sub-area of the plurality of sub-areas in which the wrong-way driver vehicle is located;
updating, at the stationary server device, map data of the sub-area based on the wrong-way driver data;
transmitting, from the stationary server device to the at least one receiver vehicle, the updated map data of the sub-area;
entering, at the at least one receiver vehicle, the updated map data of the sub-area into an on-board digital road map;
checking, at the at least one receiver vehicle, a predetermined relevance criterion met by the wrong-way driver vehicle based on the on-board digital road map,
wherein the wrong-way driver data comprises at least a current position of the wrong-way driver vehicle,
wherein the wrong-way driver data is sent from the wrong-way driver vehicle, an other vehicle, or a permanently installed monitoring device,
wherein the plurality of sub-areas are of a predetermined size, and
wherein the predetermined relevance criterion comprises:
a planned or an estimated route of the at least one receiver vehicle intersecting a route of the wrong-way driver vehicle;
the current position of the wrong-way driver vehicle being in the direction of travel of the at least one receiver vehicle;
the current position of the wrong-way driver vehicle being in front of the at least one receiver vehicle;
an indication of the at least one receiver vehicle and the wrong-way driver vehicle being on the same road based route data of the at least one receiver vehicle and route data of the wrong-way driver vehicle; and
a same roadside shared by the at least one receiver vehicle and the wrong-way driver vehicle.

12. The method of claim 11, wherein a tile having an edge length in a range of 0.01 degrees to 0.1 degrees is used as the respective sub-area.

13. The method of claim 11, further comprising:
receiving, from the at least one receiver vehicle of the plurality of receiver vehicles, registration data of each receiver vehicle of the plurality of receiver vehicles to register in at least one sub-area of the plurality of sub-areas;
in response to the received registration data, transmitting, from the stationary server device to the at least one receiver vehicle, the map data, wherein the at least one receiver vehicle is registered for the at least one sub-area of the plurality of sub-areas in which the wrong-way driver vehicle is located or the wrong-way driver vehicle is driving; and
transmitting, from the stationary server device to at least one another receiver vehicle of the plurality of receiver vehicles, the map data independently of current positions, or travel routes, or both, of the plurality of receiver vehicles.

14. The method of claim 11, further comprising:
in response to received map data, performing at least one protective measure comprising:
a notification of the wrong-way driver vehicle to the at least one receiver vehicle;
an activation of an autopilot device for performing a semi-automatic or a fully automatic driving operation of the at least one receiver vehicle,
wherein the autopilot device is configured to perform an evasive maneuver to avoid the wrong-way driver vehicle.

15. The method of claim 11, further comprising switching at least one variable traffic sign, or an electronic gantry, or both, based on at least one control signal received at the stationary server device.

16. The method of claim 11, further comprising:
detecting a wrong-way status of the wrong-way driver vehicle; and
sending the wrong-way status to the stationary server device,
wherein the wrong-way status is detected using a monitoring device installed in the wrong-way driver vehicle, a sensor device, and a downstream object recognition system,
wherein the monitoring device recognizes the wrong-way status based on a current position of the wrong-way driver vehicle, a road class currently being used with direction-of-travel separation, the digital road map,
wherein the sensor detects a steering angle signal of the wrong-way driver vehicle, and
wherein the downstream object recognition system detects an oncoming traffic, a sign, driving on an off-ramp of a highway or a freeway based on the detected steering angle signal.

17. A motor vehicle, comprising:
a control device comprising a processor configured to:
receive, from a stationary server device, map data of a sub-area in which a wrong-way driver vehicle is located ;
enter the map data of the sub-area into an on-board digital road map;
check a predetermined relevance criterion met by the wrong-way driver vehicle based on the on-board digital road map;
in response to the predetermined relevance criterion being met, perform at least one protective measure,
wherein the predetermined relevance criterion comprises:
a planned or an estimated route of the at least one receiver vehicle intersecting a route of the wrong-way driver vehicle;
the current position of the wrong-way driver vehicle being in the direction of travel of the at least one receiver vehicle;
the current position of the wrong-way driver vehicle being in front of the at least one receiver vehicle;
an indication of the at least one receiver vehicle and the wrong-way driver vehicle being on the same road based route data of the at least one receiver vehicle and route data of the wrong-way driver vehicle; and
a same roadside shared by the at least one receiver vehicle and the wrong-way driver vehicle,
thereby enabling the motor vehicle to perform as a receiver vehicle for the stationary server device by receiving notification about the wrong-way driver vehicle over an Internet.

18. The motor vehicle of claim 17, wherein the processor is further configured
to transmit, to the stationary server device, registration data to register in at least one sub-area of the plurality of sub-areas.

19. The motor vehicle of claim 17, wherein the at least one protective measure comprises a notification of the wrong-way driver vehicle, an activation of an autopilot device for performing a semi-automatic, or a fully automatic driving operation, and
wherein the autopilot device is configured to perform an evasive maneuver to avoid the wrong-way driver vehicle.

20. The motor vehicle of claim 17, wherein the processor is further configured to:
detect a wrong-way status of the wrong-way driver vehicle; and
send the wrong-way status to the stationary server device.
